(19) United States
(12) Patent Application Publication
(10) Pub. No.: US 2021/0176297 A1
(43) Pub. Date: Jun. 10, 2021

(54) RINGTONE DOWNLOAD AND PLAY SYSTEM FOR SHARED VEHICLE

(71) Applicant: HANGZHOU QINGQI SCIENCE AND TECHNOLOGY CO., LTD., Hangzhou, Zhejiang (CN)

(72) Inventors: Gang LI, Hangzhou (CN); Guotai HE, Hangzhou (CN); Meimiao FENG, Hangzhou (CN); Xiaoyun ZHOU, Hangzhou (CN); Sheng LIU, Hangzhou (CN)

(73) Assignee: HANGZHOU QINGQI SCIENCE AND TECHNOLOGY CO., LTD., Hangzhou, Zhejiang (CN)

(21) Appl. No.: 16/630,429

(22) PCT Filed: May 17, 2018
(86) PCT No.: PCT/CN2018/087306

§ 371 Date: Jan. 10, 2020

(30) Foreign Application Priority Data
May 19, 2017 (CN) 201720563404.0

(51) Int. Cl. H04L 29/08; H04M 19/04

(52) U.S. Cl. CPC H04L 67/10; H04M 19/04; H04L 67/12

(57) ABSTRACT

The embodiments of the present disclosure relate to the field of shared vehicles, and in particular, to a ringtone download and play system for a shared vehicle. The ringtone download and play system may include a lock and a cloud server disposed on the shared vehicle. The ringtone download and play system may further include a control unit disposed on the cloud server and a processing unit disposed on the shared vehicle. The cloud server may store a ringtone that is to be played in response to an operation performed on the shared vehicle. The control unit may send an instruction for downloading the ringtone to the processing unit according to an identifier of the shared vehicle. The processing unit may download the ringtone according to the instruction, and play the ringtone when the operation is performed on test shared vehicle. The ringtone play system may play different ringtones according to different scenarios, and a user may perform different operations on the shared vehicle based on ringtones. In addition, the ringtone download and play system may further automatically delete unnecessary ringtones, thereby saving memory of a storage device.

### CROSS-REFERENCE TO RELATED APPLICATIONS

This application claims priority to Chinese Patent Application NO. 201720563404.0, filed on May 19, 2017, the contents of which are hereby incorporated by reference.

### TECHNICAL FIELD

The embodiments of the present disclosure relate to the field of shared vehicles, and specifically, to a ringtone download and play system for a shared vehicle.

### BACKGROUND

With the development of shared vehicles, people are paying more and more attention to humanized designs of the shared vehicles. When a user performs an operation on a shared vehicle via a mobile phone, the user may not know whether the operation has been completed. In such cases, the user may need to be reminded by different ringtones played by the shared vehicle according to different scenarios.

Moreover, in some occasions, the shared vehicle may be placed in a remote place. When a user want to find it, the user may go to find it according to a prompt of a ringtone.

At the same time, the vehicle theft has become one of the most common crimes in cities today, which has not only caused great property damage to people, but also caused inconvenience to people's travel. If a warning sound (i.e., a ringtone) is outputted when an offender intends to unlock the shared vehicle with violence, people can catch the offender based on the ringtone, so that the offender cannot escape.

However, in existing shared vehicles, especially shared bicycles, ringtones have been installed in storage devices of the shared vehicles at the time of manufacture, and it is difficult and inconvenient to replace the ringtones, which is not good for the user experience.

### SUMMARY

The present disclosure provides a ringtone download and play system for a shared vehicle, which may solve technical problems in the prior arts that no unique ringtone is specified for an operation of the shared vehicle, and administrators cannot easily replace ringtones corresponding to each operation of the shared vehicle.

To solve the technical problem, the present disclosure provides a ringtone download and play system for a shared vehicle. The ringtone download and play system may include a lock and a cloud server disposed on the shared vehicle. The ringtone download and play system may further include a control unit disposed on the cloud server and a processing unit disposed on the shared vehicle. The cloud server may be configured to store one or more ringtones, each of which may be played in response to a specific operation performed on the shared vehicle. The control unit may be configured to send an instruction for downloading a specific ringtone to the processing unit according to an identifier of the shared vehicle. The processing unit may be configured to download the ringtone according to the instruction, and play the specific ringtone based on the operation of the shared vehicle.

In some embodiments, the ringtone download and play system may further include a storage device connected to the processing unit. The processing unit may be further configured to determine a storage situation of the storage device according to the instruction, and download the specific ringtone when it is determined that the storage device does not store the specific ringtone, or delete a ringtone corresponding to the instruction and download the specific ringtone when it is determined that the storage device has stored the corresponding ringtone.

In some embodiments, the processing unit may include a first feedback module configured to upload a download result to the cloud server when the download of the specific ringtone is successfully performed or failed.

In some embodiments, the processing unit may further include a second feedback module configured to upload a result indicating a download failure to the cloud server when it is determined that the corresponding ringtone is not deleted successfully.

In some embodiments, the ringtone download and play system may further include a play unit connected to the processing unit. The processing unit may be further configured to detect whether the storage device stores the corresponding ringtone according to the operation performed on the shared vehicle. The processing unit may be further configured to control the play unit to play the corresponding ringtone when it is determined that the storage device has stored the corresponding ringtone, or control the play unit to play a pre-stored ringtone when it is determined that the storage device does not store the corresponding ringtone.

In some embodiments, the cloud server may be further configured to store at least one of a ringtone corresponding to unlocking the lock, a ringtone corresponding to locking the lock, a ringtone corresponding to appointing the shared vehicle, a warning ringtone of the shared vehicle, or a ringtone corresponding to searching the shared vehicle.

In some embodiments, the control unit may include a ringtone upload module configured to upload the specific ringtone to the cloud server.

In some embodiments, the storage device may be a USB flash disk.

In some embodiments, the shared vehicle may be a shared bicycle.

Compared with the prior arts, one or more beneficial effects described below in the present disclosure may be achieved. The present disclosure provides a ringtone download and play system for a shared vehicle, which may play different ringtones according to different scenarios, and a user may perform different operations on the shared vehicles based on the different ringtones. The ringtone download and play system may further automatically delete unnecessary ringtones, thereby saving memory of a storage device. In addition, a structure of the ringtone download and play system may be simple, thereby realizing intelligent operation.

### BRIEF DESCRIPTION OF THE DRAWINGS

The present disclosure is further described in detail of exemplary embodiments. These exemplary embodiments are described in detail with reference to the drawings, wherein:

FIG. 1 is a schematic diagram of a ringtone download and play system according to some embodiments of the present disclosure;

FIG. 2 is a schematic diagram of a feedback module according to some embodiments of the present disclosure;

FIG. 3 is a schematic diagram of a play unit according to some embodiments of the present disclosure; and

FIG. 4 is a schematic diagram of a ringtone upload module according to some embodiments of the present disclosure.

### DETAILED DESCRIPTION

A preferred embodiment of the present disclosure will be described in detail with reference to the drawings.

As shown in FIGS. 1 to 4, the present disclosure may provide a preferred embodiment of a ringtone download and play system.

A ringtone download and play system for a shared vehicle 20 is provided. The ringtone download and play system may include a lock and a cloud server 10 disposed on the shared vehicle 20. The ringtone download and play system may further include a control unit 11 disposed on the cloud server 10 and a processing unit 21 disposed on the shared vehicle 20.

Specifically, the cloud server 10 may store one or more ringtones, each of which may be played in response to a specific operation performed on the shared vehicle 20. When a user wants to operate the shared vehicle 20, the control unit 11 may send an instruction for downloading a specific ringtone to the processing unit 21 according to an identifier of the shared vehicle 20. The processing unit 21 may download the specific ringtone according to the instruction, and play the specific ringtone base on the operation of the shared vehicle 20.

As used herein, an identifier of the shared vehicle 20 refers to a unique identification code of the shared vehicle 20.

Additionally, the ringtone download and play system may further include a storage device 22 connected to the processing unit 21. The processing unit 21 may determine a storage situation of the storage device 22 according to the instruction, and download the specific ringtone when it is determined that the storage device 22 does not store the specific ringtone, or delete a ringtone corresponding to the instruction and download the specific ringtone when it is determined that the storage device 22 has stored the corresponding ringtone, thereby saving memory of the storage device 22, such that the storage device 22 may have a sufficient memory space.

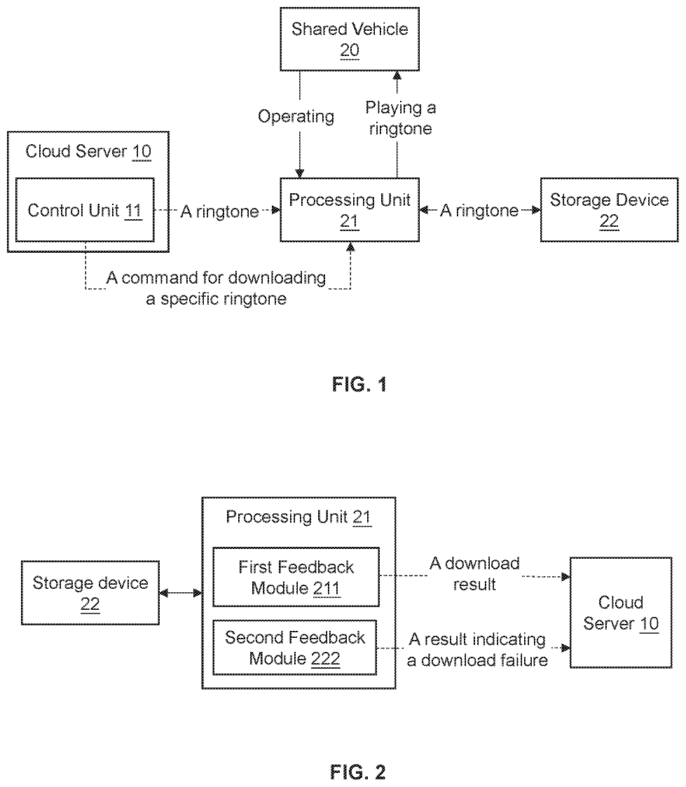

As shown in FIG. 2, the present disclosure may provide a preferred embodiment of a feedback module.

Specifically, the processing unit 21 may include a first feedback module 211. The first feedback module 211 may upload a download result to the cloud server 10 when the download of the specific ringtone is successfully performed or failed. The processing unit 21 may further include a second feedback module 212. The second feedback module 212 may upload a result indicating a download failure to the cloud server 10 when it is determined that the corresponding ringtone is not deleted successfully. The combination of the two feedback modules may ensure that a download situation may be uploaded to the cloud server 10, and prevent the processing unit 21 from downloading the specific ringtone if the corresponding ringtone is not successfully deleted, so as to prevent an extra ringtone from occupying the memory of the storage device 22.

Preferably, the storage device 22 may be a USB flash disk. The USB flash disk may operate if it is plugged in a processing device (e.g., the processing unit 21). The USB flash disk may be used as a removable storage. When the storage device 22 needs to be inspected and maintained, an administrator may unplug the USB flash disk, which is convenient for the administrator to install and remove. The storage device 22 may be any other type of storage device, such as a TF card, a memory stick, or the like.

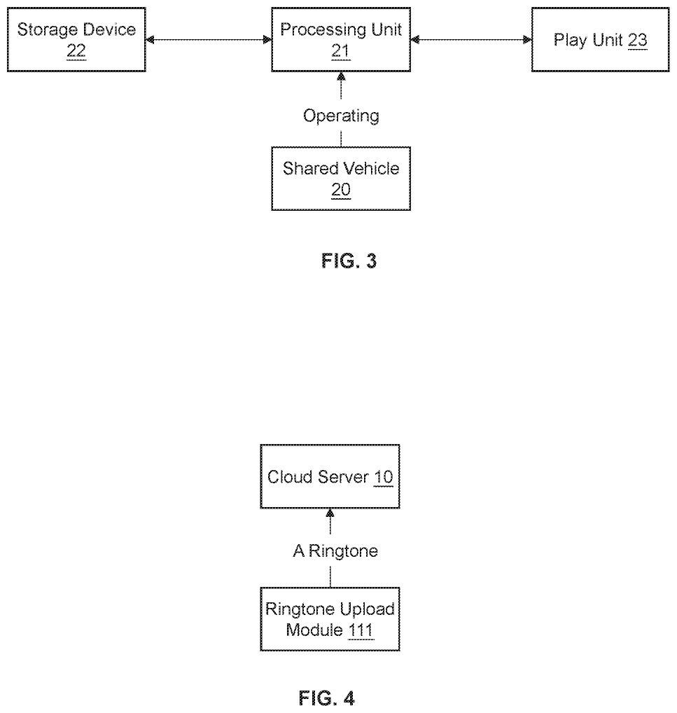

As shown in FIG. 3, the present disclosure may provide a preferred embodiment of a play unit.

Specifically, the ringtone download and play system may further include a play unit 23 connected to the processing unit 21. The processing unit 21 may detect whether the storage device 22 stores the corresponding ringtone according to the operation performed on the shared vehicle. The processing unit 21 may control the play unit 23 to play the corresponding ringtone when it is determined that the storage device 22 has stored the corresponding ringtone, or control the play unit 23 to play a pre-stored ringtone when it is determined that the storage device 22 does not store the corresponding ringtone.

In some embodiments, the cloud server 10 may store at least one of a ringtone corresponding to unlocking the lock, a ringtone corresponding to locking the lock, a ringtone corresponding to appointing the shared vehicle, a warning ringtone of the shared vehicle, or a ringtone corresponding to searching the shared vehicle. When a user uses the shared vehicle in different scenarios, the cloud server 10 may provide different ringtones. The formats of a ringtone played by the play unit 23 may include an mp3 format, an amr format, a way format, and a mid format.

Optionally, the play unit 23 may be a speaker.

As shown in FIG. 4, the present disclosure may provide a preferred embodiment of a ringtone upload module.

Specifically, the control unit 11 may include a ringtone upload module 111. If the control unit 11 detects that a specific ringtone is not stored in the cloud server 10, the control unit 11 may control the ringtone upload module 111 to upload the specific ringtone to the cloud server 10.

In the embodiment, the shared vehicle may be, but not limited to, a shared bicycle. For example, the shared vehicle may be any other type of shared vehicle, such as a shared car, a shared electric vehicle, or the like.

In summary, the above descriptions are only preferred embodiments of the present disclosure, and is not intended to limit the scope of the present disclosure. Various modification, alterations, improvements, etc. made within the spirit and principle of the embodiments of the present disclosure are within the scope of the embodiments of the present disclosure.

1. A ringtone download and play system for a shared vehicle, the system comprising:
a lock and a cloud server disposed on the shared vehicle;
a control unit disposed on the cloud server; and
a processing unit disposed on the shared vehicle;
wherein the cloud server is configured to store a ringtone that is to be played in response to an operation performed on the shared vehicle,
the control unit is configured to send an instruction for downloading the ringtone to the processing unit according to an identifier of the shared vehicle, and
the processing unit is configured to download the ringtone according to the instruction and play the ringtone when the operation is performed on the shared vehicle.

2. The ringtone download and play system of claim 1, further comprising:
a storage device connected to the processing unit;
wherein the processing unit is further configured to determine a storage situation of the storage device according to the instruction, and download the ringtone when it is determined that the storage device does not store the ringtone, or delete a ringtone corresponding to the instruction and download the ringtone when it is determined that the storage device has stored the corresponding ringtone.

3. The ringtone download and play system of claim 2, wherein the processing unit includes a first feedback module configured to upload a download result to the cloud server when the download of the ringtone is successful performed or failed.

4. The ringtone download and play system of claim 3, wherein the processing unit further includes a second feedback module configured to upload a result indicating a download failure to the cloud server when it is determined that the corresponding ringtone is not deleted successfully.

5. The ringtone download and play system of claim 2, further comprising:
a play unit connected to the processing unit,
wherein the processing unit is further configured to detect whether the storage device stores the corresponding ringtone according to the operation performed on the shared vehicle,
the processing unit is further configured to control the play unit to play the corresponding ringtone when it is determined that the storage device has stored the corresponding ringtone, or control the play unit to play a pre-stored ringtone when it is determined that the storage device does not store the corresponding ringtone.

6. The ringtone download and play system of claim 1, wherein the cloud server is further configured to store at least one of a ringtone corresponding to unlocking the lock, a ringtone corresponding to locking the lock, a ringtone corresponding to appointing the shared vehicle, a warning ringtone of the shared vehicle, or a ringtone corresponding to searching the shared vehicle.

7. The ringtone download and play system of claim 1, wherein the control unit includes a ringtone upload module configured to upload the ringtone to the cloud server.

8. The ringtone download and play system of claim 2, wherein the storage device is a USB flash disk.

9. The ringtone download and play system of claim 1, wherein the shared vehicle is a shared bicycle.

10. A ringtone download and play method for a shared vehicle, comprising:
storing a ringtone that is to be played in response to an operation performed on the shared vehicle;
generating an instruction for downloading the ringtone according to an identifier of the shared vehicle;
downloading the ringtone according to the instruction; and
playing the ringtone when the operation is performed on the shared vehicle.

11. The ringtone download and play method of claim 10, further comprising:
determining a storage situation of a storage device associated with the shared vehicle according to the instruction;
downloading the ringtone when it is determined that the storage device does not store the ringtone, or
deleting a ringtone corresponding to the instruction and downloading the ringtone when it is determined that the storage device has stored the corresponding ringtone.

12. The ringtone download and play method of claim 11, further comprising:
uploading a download result to a cloud server when the download of the ringtone is successful performed or failed.

13. The ringtone download and play method of claim 12, further comprising:
uploading a result indicating a download failure to the cloud server when it is determined that the corresponding ringtone is not deleted successfully.

14. The ringtone download and play method of claim 11, further comprising:
detecting whether the storage device stores the corresponding ringtone according to the operation performed on the shared vehicle; and
controlling a play unit to play the corresponding ringtone when it is determined that the storage device has stored the corresponding ringtone, or
controlling the play unit to play a pre-stored ringtone when it is determined that the storage device does not store the corresponding ringtone.

15. The ringtone download and play method of claim 10, wherein the ringtone includes at least one of a ringtone corresponding to unlocking the lock, a ringtone corresponding to locking the lock, a ringtone corresponding to appointing the shared vehicle, a warning ringtone of the shared vehicle, or a ringtone corresponding to searching the shared vehicle.

16. The ringtone download and play method of claim 10, further comprising:
uploading the ringtone to a cloud server.

17. The ringtone download and play method of claim 10, wherein the storage device is a USB flash disk

18. The ringtone download and play method of claim 10, wherein the shared vehicle is a shared bicycle.

19. A non-transitory computer readable medium, comprising at least one set of instructions for downloading and playing a ringtone, wherein when executed by one or more processors of a computing device, the at least one set of instructions causes the computing device to perform a method, the method comprising:
storing a ringtone that is to be played in response to an operation performed on the shared vehicle;
generating an instruction for downloading the ringtone according to an identifier of the shared vehicle;
downloading the ringtone according to the instruction; and
playing the ringtone when the operation is performed on the shared vehicle

20. The non-transitory computer readable medium of claim 19, wherein the method further comprises:
determining a storage situation of a storage device associated with the shared vehicle according to the instruction;
downloading the ringtone when it is determined that the storage device does not store the ringtone, or
deleting a ringtone corresponding to the instruction and downloading the ringtone when it is determined that the storage device has stored the corresponding ringtone.
